(19) United States
(12) Patent Application Publication
(10) Pub. No.: US 2014/0379980 A1
(43) Pub. Date: Dec. 25, 2014

(54) SELECTIVE DUPLICATION OF TAPE CARTRIDGE CONTENTS

(71) Applicant: INTERNATIONAL BUSINESS MACHINES CORPORATION, ARMONK, NY (US)

(72) Inventors: Tohru Hasegawa, Tokyo (JP); Hiroshi Itagaki, Yokohama (JP); Yumiko Ohta, Yokohama (JP); Setsuko Masuda, TOKYO (JP)

(73) Assignee: INTERNATIONAL BUSINESS MACHINES CORPORATION, ARMONK, NY (US)

(21) Appl. No.: 14/272,442

(22) Filed: May 7, 2014

(30) Foreign Application Priority Data
Jun. 21, 2013 (JP) 2013-131185

(51) Int. Cl. G06F 3/06

(52) U.S. Cl. CPC G06F 3/065; G06F 3/0617; G06F 3/0686; G06F 2003/0698
USPC 711/111

(57) ABSTRACT

A copy-source tape storage medium is prepared and includes a index partition for storing updated file metadata and associated metadata indexes and a data partition (DP) for storing valid data and associated valid data indexes and for storing invalid data that has changed or has been deleted or has been invalidated by the update and for storing associated invalid data indexes. Metadata indexes are retrieved and analyzed and a valid record number list indicating a range of record numbers of valid data is created. Records are read from the DP and data in records corresponding to record numbers not included on the valid record number list is replaced with meaningless data which is written to a copy-destination tape storage medium. Records corresponding to record numbers included on the valid record number list are copied to the copy-destination tape storage medium without alteration.

### FIELD

Embodiments of the present invention relate to a method, program and tape drive for selectively duplicating the data content of files in one or more tape cartridges.

### DESCRIPTION OF THE RELATED ART

The Linear Tape File System (LTFS) is a file system that utilizes tape storage, such as a tape library. LTFS may utilize 5^{th} generation or later Linear Tape-Open standard tape drives and TS1140 IBM Enterprise tape drives. An application utilizing LTFS need not to be aware of the library, increasing the ease of operation of the LTFS.

Data stored on tape cartridges is conventionally duplicated in order to enhance data integrity. The data stored on a tape cartridge is usually duplicated on another tape cartridge. When a cartridge includes data stored by LTFS, two different methods are used to duplicate the data.

In a first duplication methodology, data stored on a copy-source medium is accessed via the file system. The data is retrieved as a file composed of a series of currently accessible data sets (valid data) and is written as a file to the tape serving as the copy-destination medium. Because data that is only accessible via the file system is read in a cartridge duplicated using LTFS (an LTFS cartridge), data security at the destination is generally of no concern. In other words, unnecessary data (invalid data) remaining on the copy-source medium is not stored on the copy-destination medium. Therefore, there is no way to deviously access the unnecessary data if the copy-source medium is destroyed or reformatted after duplication.

In a second data duplication methodology, the data on a copy-source medium is read in record units in SCSI commands. The read data is written to the tape of the copy-destination medium without alteration. Due to the formatting characteristics of LTFS, unnecessary data (invalid data) that has been deleted or overwritten from the copy-source medium remains on the copy-destination medium along with valid data. This is not desirable, with respect to data security, because the invalid data can be deviously read from the copy-destination medium even though it has been deleted or overwritten from the copy-source medium.

Another problem with the first duplication methodology is that it takes longer than the second duplication methodology. After data has been frequently rewritten and deleted on an LTFS cartridge, the arrangement of changed data sections constituting a single file is dispersed over the length of the tape. When rearrangement to changed data sections occurs frequently, continuous reading and writing becomes impossible at high speeds using the first methodology. As a result, this duplication methodology takes longer than the second duplication methodology.

### SUMMARY

Various embodiments of the present invention solve the problem of the duplication process taking a long time when duplicating valid data on an LTFS tape cartridge at the file system level. In a cartridge (LTFS cartridge) when storing files that have been written and updated using a file system (LTFS), an index is referenced to secure information on valid data and identify data (invalid data) that has been invalidated due to deletions or rewrites via the LTFS. When data is sequentially read on the level of SCSI commands, the valid data is selectively duplicated on another cartridge. Furthermore, in this duplication method, invalid data and valid data are continuously determined from all data (records), and invalid record data is replaced by meaningless data (for example, zero data).

In a particular embodiment, a duplication method for duplicating files written to a tape storage medium by a file system includes: preparing a copy-source tape storage medium which the file system has updated files and appended updated records to the end of the files, the copy-source tape storage medium comprising a index partition (IP) for storing updated file metadata and associated metadata indexes and a data partition (DP) for storing valid data and associated valid data indexes and for storing invalid data that has changed or has been deleted or has been invalidated by the update and for storing associated invalid data indexes; retrieving, sequentially from the beginning of the copy-source tape storage medium, a data section comprising invalid data and valid data; retrieving metadata indexes of the files from the IP of the copy-source tape storage medium, analyzing the index, and creating a valid record number list indicating a range of record numbers of valid data; and sequentially reading records from the DP, referencing the valid record number list, replacing the data in records corresponding to record numbers not included on the valid record number list with meaningless data, writing the meaningless data to a copy-destination tape storage medium, and writing records corresponding to record numbers included on the valid record number list as valid data along with associated index information to the copy-destination tape storage medium without alteration.

In another embodiment, a tape drive for duplicating files written to a tape storage medium by a file system includes a controller that: prepares a copy-source tape storage medium which the file system has updated files and appended updated records to the end of the files, the copy-source tape storage medium comprising a index partition (IP) for storing updated file metadata and associated metadata indexes and a data partition (DP) for storing valid data and associated valid data indexes and for storing invalid data that has changed or has been deleted or has been invalidated by the update and for storing associated invalid data indexes; retrieves, sequentially from the beginning of the copy-source tape storage medium, a data section comprising invalid data and valid data; retrieves metadata indexes of the files from the IP of the copy-source tape storage medium, analyzes the index, and creates a valid record number list indicating a range of record numbers of valid data; and sequentially reads records from the DP, references the valid record number list, replaces the data in records corresponding to record numbers not included on the valid record number list with meaningless data, writes the meaningless data to a copy-destination tape storage medium, and writes records corresponding to record numbers included on the valid record number list as valid data along with associated index information to the copy-destination tape storage medium without alteration.

In another embodiment, a file system for duplicating files written to a tape storage medium includes a computer readable storage medium with program instructions stored thereupon that when executed implements a method comprising: preparing a copy-source tape storage medium which the file system has updated files and appended updated records to the end of the files, the copy-source tape storage medium comprising a index partition (IP) for storing updated file metadata and associated metadata indexes and a data partition (DP) for storing valid data and associated valid data indexes and for storing invalid data that has changed or has been deleted or has been invalidated by the update and for storing associated invalid data indexes; retrieving, sequentially from the beginning of the copy-source tape storage medium, a data section comprising invalid data and valid data; retrieving metadata indexes of the files from the IP of the copy-source tape storage medium, analyzing the index, and creating a valid record number list indicating a range of record numbers of valid data; and sequentially reading records from the DP, referencing the valid record number list, replacing the data in records corresponding to record numbers not included on the valid record number list with meaningless data, writing the meaningless data to a copy-destination tape storage medium, and writing records corresponding to record numbers included on the valid record number list as valid data along with associated index information to the copy-destination tape storage medium without alteration.

These and other embodiments, features, aspects, and advantages will become better understood with reference to the following description, appended claims, and accompanying drawings.

### BRIEF DESCRIPTION OF THE DRAWINGS

So that the manner in which the above recited features of the present invention are attained and can be understood in detail, a more particular description of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the invention may admit to other equally effective embodiments.

FIG. 1 depicts an exemplary hardware configuration, according to various embodiments of the present invention.

FIG. 2A-FIG. 2B depicts exemplary longitudinal methods used by a tape drive to write data and rewrite multiple files via a linear tape file system (LTFS), according to various embodiments of the present invention.

FIG. 3A-FIG. 3D depict exemplary content of an index partition and a data partition on a storage medium using the LTFS format, according to various embodiments of the present invention.

FIG. 4A-FIG. 4B depicts exemplary updated content of index information when a file is partially rewritten, according to various embodiments of the present invention.

FIG. 5 depicts a flowchart of a process for duplicating an LTFS cartridge, according to various embodiments of the present invention.

The drawings are not necessarily to scale. The drawings are merely schematic representations, not intended to portray specific parameters of the invention. The drawings are intended to depict only exemplary embodiments of the invention. In the drawings, like numbering represents like elements.

### DETAILED DESCRIPTION

The following is an explanation of an exemplary embodiment of a method for high-speed duplication of an LTFS cartridge in which data to be duplicated has been stored. In certain implementations the LTFS cartridge in which invalid data is replaced by zero data and valid data is duplicated without alteration. When data recorded using LTFS is duplicated, the data on the copy-source tape may be read sequentially from the beginning and may be duplicated on the copy-destination tape while determining the validity of the read data. For example, duplication is performed on the record level of SCSI commands without using the file system. The invalid data deleted or rewritten at this time while accessed via the LTFS has been determined in advance. When record data is duplicated on the record level, the record data may be replaced with meaningless data.

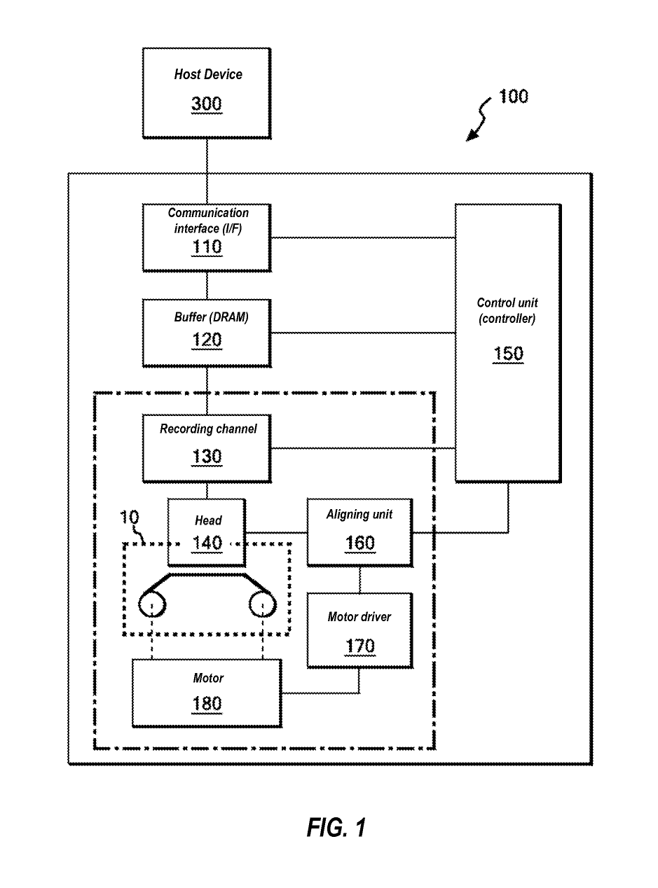

FIG. 1 shows an example of a hardware configuration of a tape drive (tape recording device) to which an example of the present invention has been applied. This tape recording device 100 may include a communication interface (I/F) 110, a buffer 120, a recording channel 130, a read/write head 140, a control unit 150, an aligning unit 160, a motor driver 170, and a motor 180.

The interface 110 communicates with a host device 300 via a network. For example, the interface 110 receives from the host device 300 write commands instructing the device to write data to a tape storage medium 10 (e.g. cartridge, etc.). The interface 110 also receives from the host device 300 read commands instructing the device to read data from the medium 10. The interface 110 has a function for compressing write data and decompressing compressed read data. This function increases the actual storage capacity of the medium 10 relative to the data by nearly a factor of two. For example, when the same data is continued with zero data, the compression rate of the written data is increased and storage capacity is saved on the medium 10.

The tape drive 100 reads and writes to the medium 10 in data set (DataSet, DS) units composed of a plurality of records sent from the host device 300. An exemplary size of a DS is 4 MB. The host device 300 specifies files in the file system or records in SCSI commands when sending write/read requests to the tape drive. DS are composed of a plurality of records.

Each DS includes management information related to the data set. User data is managed in record units. Management information includes a data set information table (DSIT). A DSIT includes the number of records and FMs in the DS, and the cumulative number of records and FMs that have been written the medium.

The buffer 120 is memory used to temporarily store data to be written to the medium 10 or data to be read from the medium 10. For example, the buffer 120 may be dynamic random-access memory (DRAM). A recording channel 130 is a communication pathway used to write data stored in the buffer 120 to the medium 10 or to temporarily store data read from the medium 10 in the buffer 120.

The read/write head 140 includes a data read/write element for writing data to the medium 10 and reading data from the medium 10. The read/write head 140 in the present embodiment has a servo read element for reading signals from the servo tracks provided on the medium 10. The aligning unit 160 directs the movement of the read/write head 140 in the shorter direction (width direction) of the medium 10. The motor driver 170 drives the motor 180.

The tape drive 100 writes data to a tape and reads data from a tape in accordance with commands received from the host device 300. The tape drive 100 includes a buffer, a read/write channel, a head, a motor, tape-winding reels, read/write controls, a head alignment control system, and a motor driver. A tape cartridge is detachably loaded in the tape drive. The tape moves longitudinally as the reels rotate. The head writes data to the tape and reads data from the tape as the tape moves longitudinally. The medium 10 includes non-contact/non-volatile memory called cartridge memory (CM). The tape drive 100 reads and writes to the CM installed in the medium 10 in a non-contact manner. The CM stores cartridge attributes. During reading and writing, the tape drive retrieves cartridge attributes from the CM in order to perform the read/write operation properly.

The control unit 150 controls the entire tape recording device 100. In other words, the control unit 150 controls the writing of data to the medium 10 and the reading of data from the medium 10 in accordance with commands received via the interface. The control unit 150 also controls the aligning unit 160 in accordance with retrieved servo track signals. In addition, the control unit 150 controls the operation of the motor via the aligning unit 160 and the motor driver 170. The motor driver 170 may be connected directly to the control unit 150.

In embodiments of the present invention, special commands (tools, programs) read and duplicate data sequentially to the tape medium at the level of SCSI commands. These commands distinguish data sections (invalid data) from an index which are no longer necessary because a file has been partially deleted or changed and duplicates currently valid data to another medium.

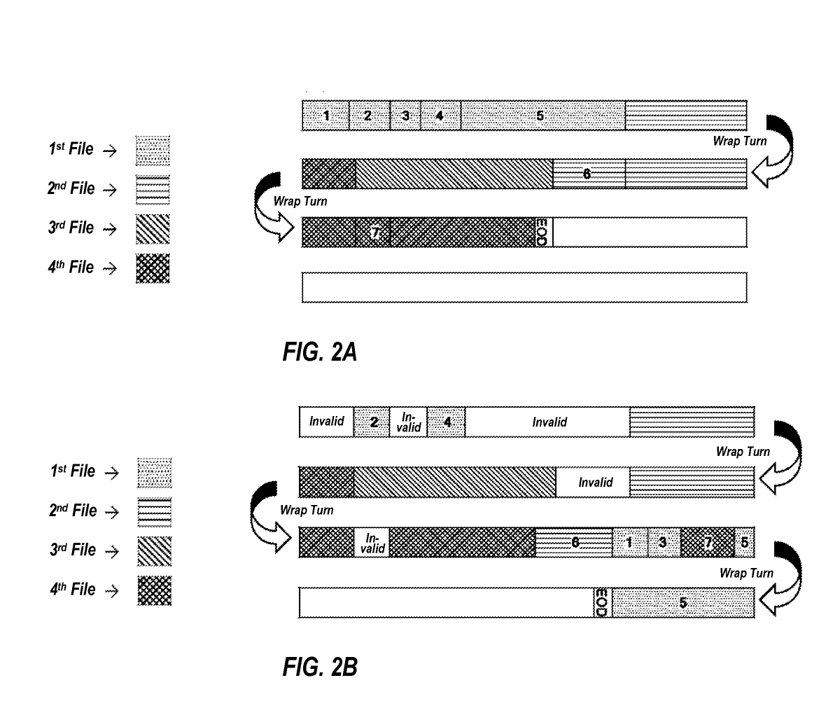

FIG. 2A-FIG. 2B show a longitudinal methodology used by tape drive 100 to write data and partially change multiple files multiple via a linear tape file system (LTFS). Each file is distinguished by a pattern classification. In FIG. 2A, each file is initially recorded in a continuous manner (1st, 2nd, 3rd, 4th files). In FIG. 2B, data sections 1, 3 and 5 of the 1st file have been overwritten, deleted or otherwise changed, but data sections 2 and 4 have not been changed. Data section 6 in the second file has been changed. Data section 7 in the 4th file has been changed. The original data for the data sections that have been changed remains on the medium as invalid data. The new data for changed data sections 1, 3 and 5 is appended (append write) sequentially after the EOD (end of data) of the files. In both FIG. 2A and FIG. 2B, the sequence for reading the data sections of the 1st file from the medium is 1, 2, 3, 4 and 5. In order to read the data sections sequentially from the beginning of the 1st file after the file has been changed in FIG. 2B, the tape has to be realigned many times.

The read/write operation can be performed continuously in an advantageous manner because the reading of data stored on the tape can be performed sequentially from the beginning using SCSI commands. If the records are read continuously in sequence, adequate performance of the tape drive can be realized. However, when data read on the SCSI command level is written without alteration, the invalid data is duplicated without alteration and the data security problem remains.

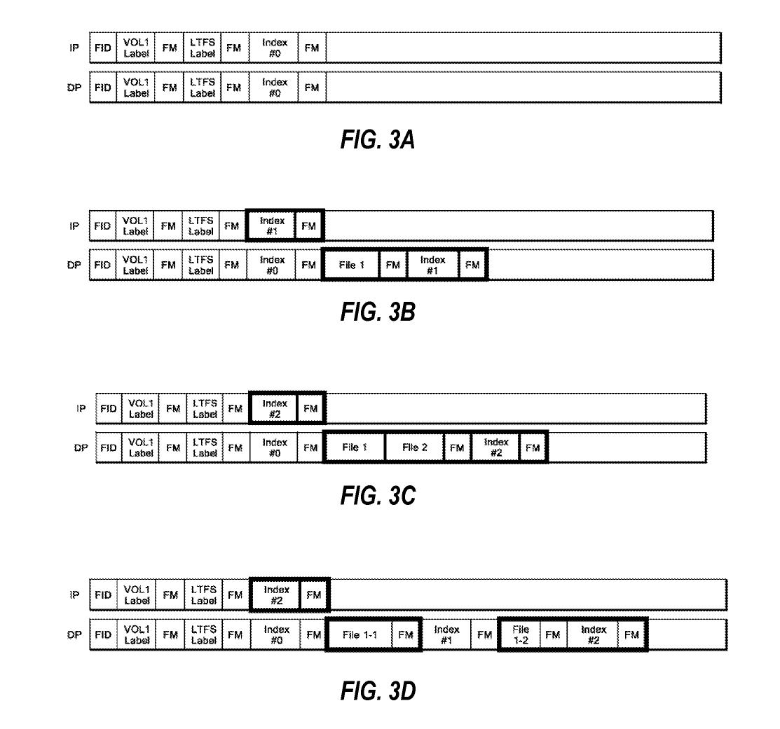

FIG. 3A-FIG. 3D show the content of an index partition and a data partition on a medium 10 using the LTFS format. In LTFS, files are read to and written from the tape medium 10, but the tape medium 10 has to first be initialized using the LTFS format. When a tape medium 10 uses LTFS, the tape medium 10 is partitioned into two partitions called the index partition (IP) and the data partition (DP). When a user writes to a tape medium 10 using LTFS, metadata called an index file (or simply the “index” below) is written to the tape medium 10 in addition to the files themselves. The index includes information such as the file name and file creation date. An updated index is written to the IP. The files themselves and an index history are written to the DP.

When files are read and written to a tape medium 10 using LTFS, the data is read and written in units known as records. Records are managed using ordinal numbers indicating the Nth record from the beginning of each partition in which records are recorded, and each file and information on its corresponding records (for example, File A is composed of Record N through Record N+α) are stored in the index.

When data written to a tape medium 10 is read and the data is read in the order in which it was written on the tape medium 10, the data can be read at a transfer rate of 140 MB/sec in the case of a fifth-generation LTO tape drive (LTO5). When the read data is scattered throughout the tape medium 10, the seek operation for each tape segment requires anywhere between an average of 30 seconds and a maximum of over a minute. This significantly decreases the average read transfer rate.

One tape medium 10 is partitioned into an index partition and a data partition. The configuration of the example in the drawing is for an LTO5-compatable medium. In this example, the tape is partitioned in two to create an index partition (IP) and a data partition (DP) from the beginning of the tape (BOT) to the end of the tape (EOT). The medium 10 is divided into an index partition in the beginning portion and a data partition taking up most of the tape recording area along the track for recording data. Depending on the specifications, three or more partitions are possible.

FIG. 3A depicts information written to tape medium 10 immediately after the tape medium 10 has been initialized using the LTFS format. For example, the information shown in FIG. 2A is to be written to the tape medium immediately after the tape medium has been initialized using the LTFS format.

FID (Format Identification Dataset) is special data written at the beginning of the tape medium 10 when the tape drive 100 initializes the tape medium 10, and includes information such as the number of partitions in the tape medium 10 and the capacity of each partition.

VOL1Label, also called the ANSI Label, is a general format label defined by ANSI. LTFSLabel is a label stipulated by the LTFS format and holds information indicating which version of the LTFS format was used to format the tape medium 10. The size of the records recorded on the medium 10 is indicated within the LTFSLabel. The record size is also known as the block size. The record size is ensured even when the end of the file is less than the block size (for example, 512 KB).

FM (Filemarks) are commonly used in tape media. These are used to specify the head of data (seek), and function similar to bookmarks. Index #0 is the index written during formatting. At this stage, FM does not include file-specific information because no files are present but rather holds information such as the volume name of the tape medium.

FIG. 3B shows information written to a tape medium 10 when a file has been written after the tape medium 10 has been initialized using the LTFS format. FIG. 3B shows the data written to the tape medium 10 when a file (File 1) is written after initialization of the tape medium 10 using the LTFS format. The portion demarcated by the bold lines is added/updated data. Index#1 has information on File 1. The IP only holds an updated index. The DP holds the index history. The timing for updating the index is left to the implementation of the file system. Updates may be performed at fixed time intervals or may be updated only when a tape medium 10 is removed from the tape drive. Even in the case of further continued use, the index positioned in the IP is always only the most recent index, and files and indices are appended to the DP without overwriting the existing indices.

FIG. 3C shows information written to a tape medium 10 when another file has been written (File 2) following the state shown in FIG. 3B. When a directory has been written to the tape medium 10 and other files and directories have been written to the tape medium 10, the files are appended to the initially written directory, and File 1 and File 2 are stored consecutively on the tape medium 10.

FIG. 3D shows information written to a tape medium 10 following the state shown in FIG. 3B when character information (File 1-2) has been appended to the end of File 1 and File 1 has been updated. After a file written to the tape medium 10 has been updated using a document creating application, a single file (File 1) is dispersed and recorded as File 1-1 and File 1-2. Because alignment is required when reading the file, the reading operation takes time.

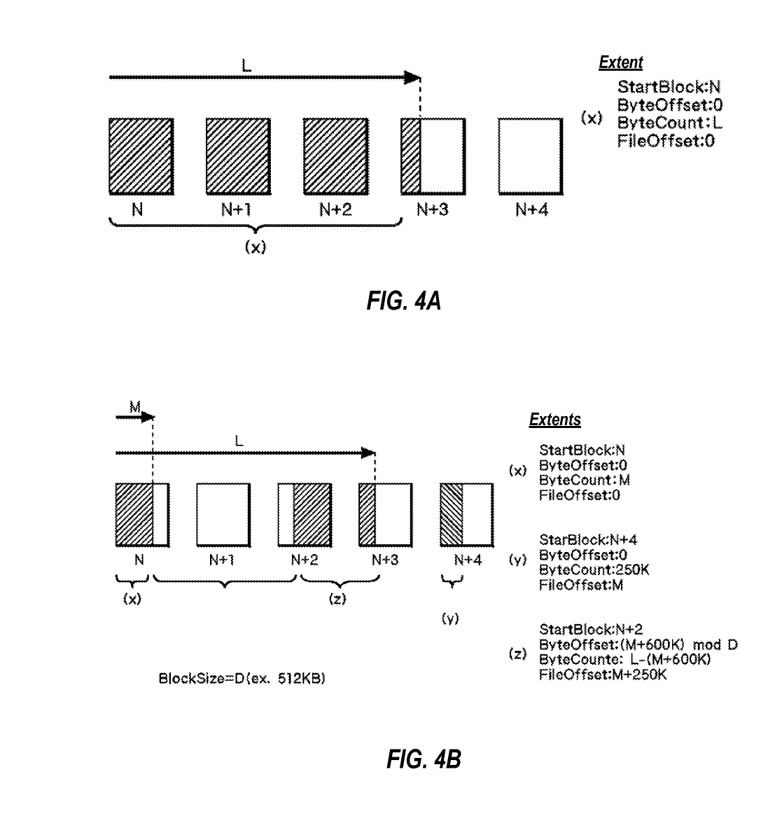

FIG. 4A-FIG. 4B depicts exemplary updated content of index information when a file is partially rewritten, according to various embodiments of the present invention. In an index, file position information (pointers) are stored in a format called an “extent”. Extent elements include the number of the block (StartBlock) at the beginning of a file portion (data portion), the start offset (ByteOffset) inside the block of this number, the size of the data (ByteCount), and the file position in the data portion (FileOffset). User data is stored on the medium 10 in record units of a size determined by the block size (for example, 512 KB). StartBlock indicates the order of blocks of a fixed size from the beginning of the tape medium. ByteOffset indicates the offset for the beginning of writing inside a block of a particular number. ByteCount indicates the data size of the data portion indicated by the extent. FileOffset indicates the file position in the data portion indicated by the extent. A block includes a record or Filemark (FM: record delimiter), and the size is indicated in the LTFS Label. The user data is recorded in the medium 10 in record units of a size determined by the block size (for example, 512 KB).

Initially as depicted in FIG. 4A, when the size of a file (File 1) recorded on the medium is L, the index indicates extent (x). File 1 is written continuously in record units on the tape medium 10 in the longitudinal direction as indicated by the cross-hatched portion. The records correspond to blocks in the extent. When a data portion is rewritten after File 1 has been written, as shown in FIG. 4B, and 600 KB from the M bytes of File 1 have been replaced with 250 KB record, extents (x), (y) and (z) are written. Extent (y) indicates the 250 KB data (record) in which 600 KB have been changed and written to a data portion of File 1. The data portions are not consecutive, so this is appended as a record of successive block numbers (StartBlock: N+4). In extent (y), 250 KB is appended (append write) from ByteOffset=0 of StartBlock=N+4. Extent (x) indicates the data (record) to ByteCount=M of StartBlock=N. Here, 600 KB of data has been changed from offset M of Block N. Extent (z) indicates a data portion of ByteCount=L−(M+600) from ByteOffset=(M+600 K) modD of StartBlock=N+2. Here, D is the block size (for example, 512 KB). ByteOffset is the remainder of M+600 KB divided by D, and the offset is provided in block number N+2. The index of File 1 includes dispersed alignment information such as extents (x) (y) (z) due to the rewriting of data portions. File 1 dispersed among extents due to repeated changes using LTFS cannot be accessed sequentially. Therefore, access of extents (x) (y) (z) requires rewinding the tape, and this causes access performance to deteriorate.

There is a relationship between a valid file and record numbers when using the LTFS format. In LTFS, a current list of valid files and the record numbers for the data constituting the files is recorded. More specifically, the beginning record number for the data constituting the file and the length of the subsequent data is recorded and a single file may consist of a plurality of records (beginning record numbers and lengths). LTFS uses two partitions of the tape, and a VOL label (VOL1Label) and LTFS label (LTFSLabel) are recorded at the beginning of each partition. LTFSLabel indicates that the cartridge is formatted using LTFS and also records the record size used on the cartridge. If a record size is used, the record numbers to be used can be calculated ahead of time (from the beginning record and the length of the subsequent data).

Invalid data may be distinguished from valid data in an LTFS cartridge by reading SCSI commands. When reading and writing using SCSI commands, reading is performed sequentially from the beginning of the medium (EOT), the record number (block number) is counted each time a record is read, and the record position is indicated by block number. Meanwhile, in the LTFS format, the record location of valid data for a file is indicated in the index using a block number range (offset, size). In other words, in the case of the valid data for files that have been updated several times the block number range indicated by extents in an index stored in the IP can be verified on a list of valid record numbers. Therefore, invalid data can be identified during sequential reading on the SCSI level when data has a record number which is outside a record count.

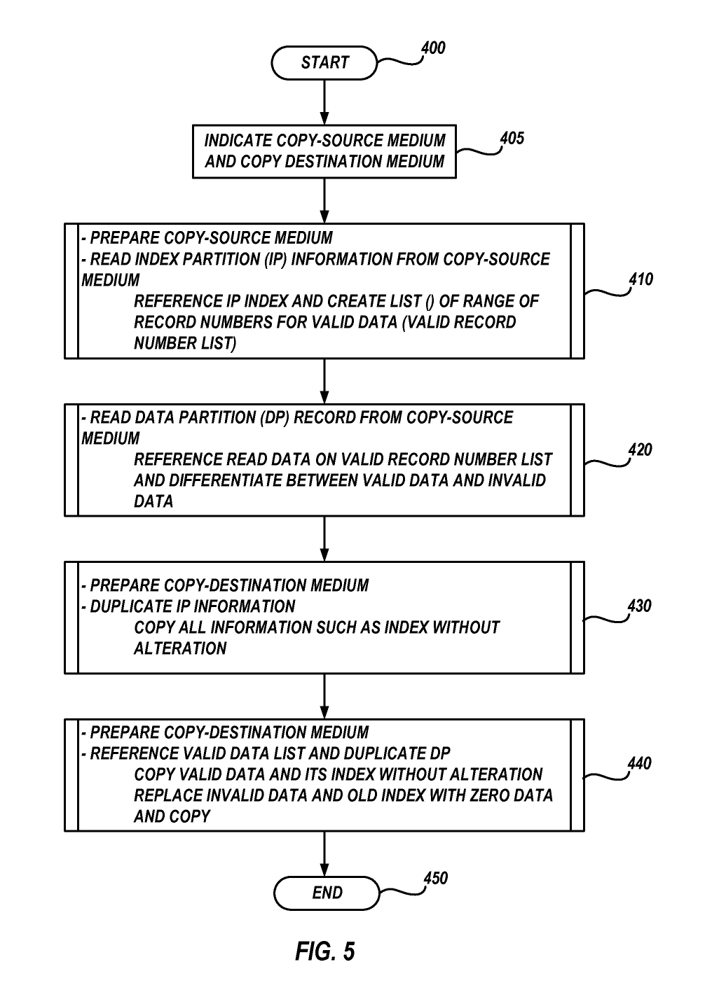

FIG. 5 depicts a flowchart of a process for duplicating an LTFS cartridge, according to various embodiments of the present invention. More specifically, records are read sequentially from the beginning of the medium using SCSI commands and, as each record is analyzed, the records indicated by the index stored in the IP are used to identify valid data. The special commands maintain the LTFS format, and differentiate between read valid data and invalid data in the duplication process. Duplication using the special commands of embodiments of the present invention may require ensuring that subsequent reading of data from the copy-destination medium can be performed using LTFS. Therefore, the LTFS format information on the copy-source medium also has to be preserved on the copy-destination medium. Thus, invalid data is written according to size. However, in order to provide security and keep others from obtaining the content, all invalid data is changed, for example, to zeroes, and this is duplicated on the destination medium. The writing compression rate is also increased when all invalid data and/or old index files is replaced by zeroes. Any values can be used to change invalid data as long as the original data is changed.

Invalid data is in a record that is not referenced using the index described above. Therefore, before the actual duplication is performed, the index is read, valid record numbers are listed, and a list is created of record numbers that are not to be referenced.

At block 400, the processing flow begins to duplicate the content of a copy-source medium (old medium) storing files using LTFS to a new copy-destination medium (new medium) using SCSI commands.

At block 405, the old medium storing the files to be duplicated and the new medium are specified. Because tape library systems usually have two or more tape drives, the old medium may be loaded into one tape drive and the new medium may be loaded into another tape drive. When a tape library system only has a single tape drive, the necessary data is stored in system memory or on the host device after the old medium has been loaded, the IP and DP have been read, and the data has been secured. The old medium is then unloaded, the stored data is identified as valid and invalid data, the new medium is loaded, and the writing operation is performed. When the host device and system memory have size constraints the old medium and the new medium are alternated and repeatedly loaded and unloaded from the single tape drive.

At block 410, the IP of the old medium written using the LTFS format is read and the index information is secured. A valid data list is created from the index information. The valid data list is used to identify data that has been invalidated by updates and deletions when the DP is sequentially read in a later step (block 440). All data that is not valid data is treated as invalid data.

At block 420, The DP of the old medium written using the LTFS format is read sequentially from the beginning and valid data and invalid data are differentiated. The valid record number list created when the IP was read is referenced to determine whether read records are on the valid data list.

At block 430, the new medium is loaded into a tape drive and prepared. The index partitions acquired from the old medium are duplicated on the new medium. All information such as indices are copied to the new medium without alteration.

At block 440, the new medium is loaded into a tape drive and prepared. The valid data number list is referenced and the valid data and/or old indices in the read records are duplicated on the copy-destination medium. The valid data and indices in the records read from the old medium are duplicated in the DP of the new medium. The valid record number list is referenced to identify invalid data and/or old indices not corresponding to the valid data stored in the DP among the records read from the old medium, the invalid data and/or old indices are replaced with zero data, and the replaced data is duplicated in the DP of the new medium.

While the old medium is read sequentially (at block 410), the records can be counted and the record numbers for all records can be secured. When the invalid data is differentiated (at block 420), the indices secured from the IP are analyzed and a valid record number list is created. More specifically, the number ranges of valid records can be identified from the extents included in the indices and the number ranges are collected in the valid record number list. The numbers of records (from block 410) that have been read can be checked against the valid record number list and, when a number is not on the list, the record can be identified as invalid data (at block 420). In the duplication operations (at blocks 430, 440), the valid record number list can be used to duplicate invalid records as meaningless data when writing records from the old medium to the new medium. For example, the records are counted on the level of SCSI commands while records corresponding to invalid data are replaced with all zeroes. When valid data corresponds to a valid record number, the read record and index are written to the new medium without alteration. The invalid data is not written using random data in order to avoid a situation in which the compression rate of the tape drive is changed and all of the data cannot fit on the copy-destination cartridge. When said data is replaced by zeroes, the compression rate is very high, and the effect is to increase the amount of free capacity on the copy-destination cartridge during the duplication process. When a file mark is read after an invalid record, the file mark (FM) is written to the copy-destination cartridge without alteration, and without replacing the file mark with zero data.

A tape drive to which the present invention has been applied enables high-speed duplication while preventing the invalid data remaining on a tape from being correctly readable. The present invention was explained using an exemplary embodiment, but the scope of the present invention is not limited to this example. It should be apparent to those skilled in the art that various changes and modifications can be made without departing from the spirit and scope of the present invention.

The invention claimed is:

1. A duplication method for duplicating files written to a tape storage medium by a file system, the method comprising:
preparing a copy-source tape storage medium which the file system has updated files and appended updated records to the end of the files, the copy-source tape storage medium comprising a index partition (IP) for storing updated file metadata and associated metadata indexes and a data partition (DP) for storing valid data and associated valid data indexes and for storing invalid data that has changed or has been deleted or has been invalidated by the update and for storing associated invalid data indexes;
retrieving, sequentially from the beginning of the copy-source tape storage medium, a data section comprising invalid data and valid data;
retrieving metadata indexes of the files from the IP of the copy-source tape storage medium, analyzing the index, and creating a valid record number list indicating a range of record numbers of valid data; and
sequentially reading records from the DP, referencing the valid record number list, replacing the data in records corresponding to record numbers not included on the valid record number list with meaningless data, writing the meaningless data to a copy-destination tape storage medium, and writing records corresponding to record numbers included on the valid record number list as valid data along with associated index information to the copy-destination tape storage medium without alteration.

2. The duplication method according to claim 1, wherein the copy-destination tape storage medium comprises an IP and an DP, and wherein the IP and DP of the copy-destination tape storage medium and the IP and the DP of the copy-source tape storage medium are longitudinal partitions.

3. The duplication method according to claim 1, wherein the metadata indexes store extents corresponding to file records, the extents comprising: a block number, a logic offset, a size, and a file record offset.

4. The duplication method according to claim 1, wherein the DP stores a record and a valid data index at a position indicated by the index and wherein the DP appends a record portion that has changed due to the update to the end of the record data.

5. The method according to claim 2, wherein reading sequential records from the DP and writing records corresponding to record numbers included on the valid record number list as valid data is triggered by one or more SCSI commands.

6. The duplication method according to claim 5, wherein reading sequential records further comprises:
reading data from the beginning of the copy-source tape storage medium sequentially in record units while counting.

7. The duplication method according to claim 5, wherein creating a valid record number list further comprises:
analyzing a plurality of extents and creating a range of record numbers for records corresponding to updated valid data as a valid record number list.

8. The duplication method according to claim 5, wherein writing records corresponding to record numbers included on the valid record number list as valid data to the copy-destination tape storage medium further comprises:
verifying count numbers of the records read from the beginning of the copy-source tape storage medium, referencing the valid record number list, and distinguishing between invalid data and valid data in the read records.

9. The duplication method according to claim 8, wherein writing the meaningless data to a copy-destination tape storage medium further comprises:
replacing the data in the read records and associated bad data indexes with zeroes and writing the replaced records and the replaced indexes to the copy-destination tape storage medium.

10. A tape drive for duplicating files written to a tape storage medium by a file system, the tape drive comprising a controller that:
prepares a copy-source tape storage medium which the file system has updated files and appended updated records to the end of the files, the copy-source tape storage medium comprising a index partition (IP) for storing updated file metadata and associated metadata indexes and a data partition (DP) for storing valid data and associated valid data indexes and for storing invalid data that has changed or has been deleted or has been invalidated by the update and for storing associated invalid data indexes;
retrieves, sequentially from the beginning of the copy-source tape storage medium, a data section comprising invalid data and valid data;
retrieves metadata indexes of the files from the IP of the copy-source tape storage medium, analyze the index, and create a valid record number list indicating a range of record numbers of valid data; and
sequentially reads records from the DP, references the valid record number list, replaces the data in records corresponding to record numbers not included on the valid record number list with meaningless data, writes the meaningless data to a copy-destination tape storage medium, and writes records corresponding to record numbers included on the valid record number list as valid data along with associated index information to the copy-destination tape storage medium without alteration.

11. The tape drive according to claim 10, wherein the copy-destination tape storage medium comprises an IP and an DP, and wherein the IP and DP of the copy-destination tape storage medium and the IP and the DP of the copy-source tape storage medium are longitudinal partitions.

12. The tape drive according to claim 10, wherein the metadata indexes store extents corresponding to file records, the extents comprising: a block number, a logic offset, a size, and a file record offset.

13. The tape drive according to claim 10, wherein the DP stores a record and a valid data index at a position indicated by the index and wherein the DP appends a record portion that has changed due to the update to the end of the record data.

14. The tape drive according to claim 11, wherein the read of sequential records includes reading data from the beginning of the copy-source tape storage medium sequentially in record units while counting.

15. The tape drive according to claim 11, wherein the sequential read by the controller includes reading data from the beginning of the copy-source tape storage medium sequentially in record units while counting.

16. The tape drive according to claim 11, wherein the creation of the valid record number list includes analyzing a plurality of extents and creating a range of record numbers for records corresponding to updated valid data as a valid record number list.

17. The tape drive according to claim 11, wherein the write of records corresponding to record numbers included on the valid record number list as valid data to the copy-destination tape storage medium includes verifying count numbers of the records read from the beginning of the copy-source tape storage medium, referencing the valid record number list, and distinguishing between invalid data and valid data in the read records.

18. The tape drive according to claim 17, wherein the write of the meaningless data to the copy-destination tape storage medium includes replacing the data in the read records and associated bad data indexes with zeroes and writing the replaced records and the replaced indexes to the copy-destination tape storage medium.

19. The tape drive according to claim 10, further comprising: a communication interface communicatively coupled to the controller, a buffer communicatively coupled to the controller and to the communication interface, a recording channel communicatively coupled to the controller, to the buffer, and to a read/write head.

20. A file system for duplicating files written to a tape storage medium, the file system including a computer readable storage medium with program instructions stored thereupon that when executed implements a method comprising:
preparing a copy-source tape storage medium which the file system has updated files and appended updated records to the end of the files, the copy-source tape storage medium comprising a index partition (IP) for storing updated file metadata and associated metadata indexes and a data partition (DP) for storing valid data and associated valid data indexes and for storing invalid data that has changed or has been deleted or has been invalidated by the update and for storing associated invalid data indexes;
retrieving, sequentially from the beginning of the copy-source tape storage medium, a data section comprising invalid data and valid data;
retrieving metadata indexes of the files from the IP of the copy-source tape storage medium, analyzing the index, and creating a valid record number list indicating a range of record numbers of valid data; and
sequentially reading records from the DP, referencing the valid record number list, replacing the data in records corresponding to record numbers not included on the valid record number list with meaningless data, writing the meaningless data to a copy-destination tape storage medium, and writing records corresponding to record numbers included on the valid record number list as valid data along with associated index information to the copy-destination tape storage medium without alteration.
